(19) United States
(12) Patent Application Publication
(10) Pub. No.: US 2015/0369513 A1
(43) Pub. Date: Dec. 24, 2015

(54) Check Valve for Ventilation System

(71) Applicant: UDLEJER HANS JØRGEN CHRISTENSEN, Hadsten (DK)

(72) Inventor: Hans Jørgen CHRISTENSEN, Hadsten (DK)

(21) Appl. No.: 14/761,489

(22) PCT Filed: Feb. 7, 2014
(86) PCT No.: PCT/DK2014/050033

§ 371 Date: Jul. 16, 2015

(30) Foreign Application Priority Data
Jan. 18, 2013 (DK) PA 2013 00036

(51) Int. Cl. F24F 13/10; F16K 15/14; F16K 24/04

(52) U.S. Cl. CPC F24F 13/105; F16K 24/04; F16K 15/148

(57) ABSTRACT

An air inlet valve including a housing with an opening, a cover plate and a centered rod for connecting the cover plate to the housing, wherein the air inlet valve furthermore includes a check valve plate made from a flexible sheet material and in which is provided at least one slot, extending from an outer perimeter of the check valve plate and towards center, and a central opening suitable for holding the check valve plate firmly on the centered rod, such that the check valve plate can be held firmly on the rod between the opening in the housing and the cover plate when the air inlet valve is assembled.

### TECHNICAL FIELD

The present invention concerns an air inlet valve with a check valve and use of a check flap for retrofitting in air inlet valves in ventilation systems.

### BACKGROUND

In ventilation systems, it is often necessary to slow down the return flow of air, e.g. from living rooms and other rooms in dwellings, into ventilation pipes when the ventilation system is not running. If these ventilation pipes are located e.g. in a cold attic, condensation can form in the pipes, which may drip down into the room and may damage the ceiling cladding. Another function may be that this check flap retains cold draughts from the outside (e.g. in solar air collector systems) at night.

It is often difficult and costly to retrofit currently commercially available check flaps, since these are larger and take up substantially more space in the pipe in which they are to be inserted.

### BRIEF SUMMARY

The present invention concerns the use of a check valve plate which is preferably made from a flexible plastic material and which can be inserted directly in existing and new inlet valves, and which due to its design effectively prevents backflow of air. The check valve plate itself offers very little resistance to the air in the inlet direction, but enough to prevent a large part of e.g. cold draught. It is fitted in a novel way, namely inside the existing valve itself, so that it both slows down the air penetration as early as possible and is very easy to install. The invention also concerns an air inlet valve with such a check valve plate fitted, and thus concerns an air inlet valve comprising a housing with an opening, a cover plate, and a centered rod for connecting said cover plate to said housing, wherein said air inlet valve furthermore comprises a check valve plate which is made from a flexible sheet material and in which is provided at least one slot, extending from an outer perimeter of said check valve plate and towards its center, and a central opening suitable for holding said check valve plate firmly on said centered rod such that said check valve plate can be held firmly on said rod between said opening in said housing and said cover plate when said air inlet valve is assembled.

The slot ensures that the flexible check valve plate will assume a tapering shape when mounted in the air inlet valve, substantially with a surface of conical form with the tip pointing against the primary flow direction of the air in said air inlet valve.

The centered rod preferably comprises an on the cover plate mounted centered adjusting screw suitable for cooperating with a centered hole with internal thread in the housing, such that said adjusting screw and said hole can cooperate to make the distance between said cover plate and said opening adjustable. Furthermore, a nut may be mounted on the adjusting screw such that the check valve plate is placed on said adjusting screw between said nut and the hole in the housing.

The opening in the housing is preferably circular and in a particularly preferred embodiment is funnel-shaped with the pointed end facing against the primary flow direction of the air in the air inlet valve. The check valve plate preferably also has a substantially circular perimeter and a diameter which exceeds a diameter of the housing opening, so that it assumes a conical shape on mounting.

The at least one slot can extend obliquely or curve helically towards the center of the check valve plate, but it is preferred that the slot extends rectilinearly radially from the perimeter of said check valve plate towards its center. In such a preferred embodiment, the check valve plate comprises two or three such slots.

In one embodiment of the invention, more than three slots can be used.

The check valve plate is preferably made from a sheet material, the flexibility of which is temperature-dependent, such that the properties of said check valve plate as a check valve will be substantially changed between operating temperatures of 0° C. and 25° C. This feature is used to hold the valve closed to a greater extent when cold air flows over it and thus contributes further to reducing the risk of e.g. cold draughts from a ventilation system or a solar air collector when these are not in operation.

The check valve plate is preferably made from a flexible plastic material, preferably polypropylene or PET, preferably with a thickness between 80 and 200 μm.

The invention furthermore concerns the use of a check valve plate made from a flexible sheet material in which is provided at least one slot extending from an outer perimeter of said check valve plate and towards its center, and a central opening, as a check valve plate in an air inlet valve, which comprises a housing with an opening, a cover plate, and a centered rod for connecting said cover plate to said housing, wherein said rod has been led through said central opening of said check valve plate so that said check valve plate is held firmly on said rod between said opening in said housing and said cover plate when the air inlet valve is assembled. The check valve plate preferably comprises one or more of the preferred technical features of the check valve plate described above.

The check valve plate can be produced in varying thicknesses and types of plastic material, and can furthermore be produced with several layers (including metal) which work differently from each other to achieve an effect as known from bimetal springs etc. The effect of varying temperatures on the ability of the invention to bend at varying temperatures can thus be controlled.

The traditional metal check flap has the unfortunate property of often generating noise when e.g. it is windy outside. No audible noise is generated by the invention when the flaps move. The invention can furthermore be delivered with instructions in a generally small envelope, which makes it cheap to purchase.

### BRIEF DESCRIPTION OF THE DRAWINGS

An embodiment of the invention is shown in the attached drawings in which:

FIG. 1 shows a check valve plate in the form of a plastic disc with various slots, ready for installation in an air inlet valve,

FIG. 2 shows a cross-sectional view of a typical air inlet valve,

FIG. 3 shows the same as FIG. 2, with a plastic disc inserted as a check valve plate which prevents backflow of air in accordance with the invention,

FIG. 4 shows the same as FIG. 3, with the plastic disc opening automatically for the airflow, and

FIG. 5 shows a series of pictures of the steps required for installing a check valve plate in the form of a plastic disc in a known air inlet valve.

### DETAILED DESCRIPTION

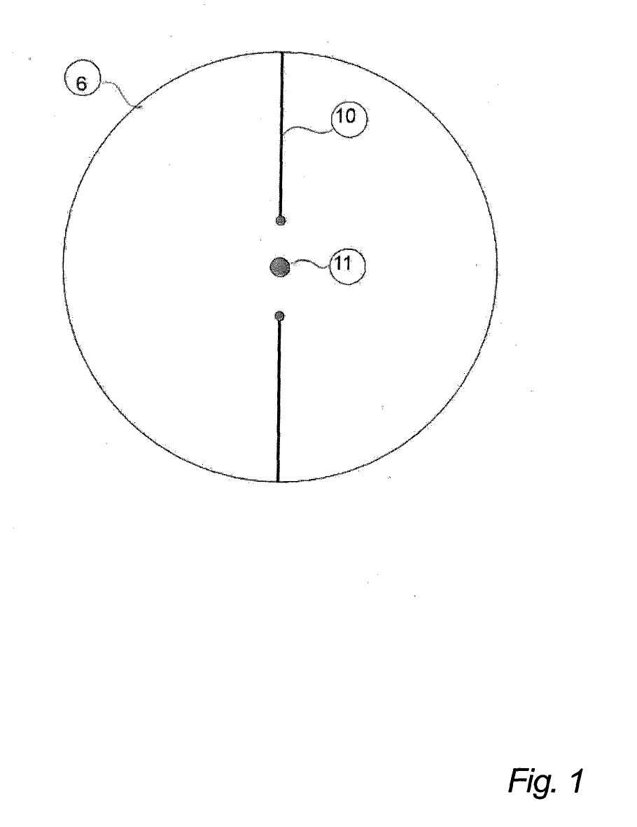

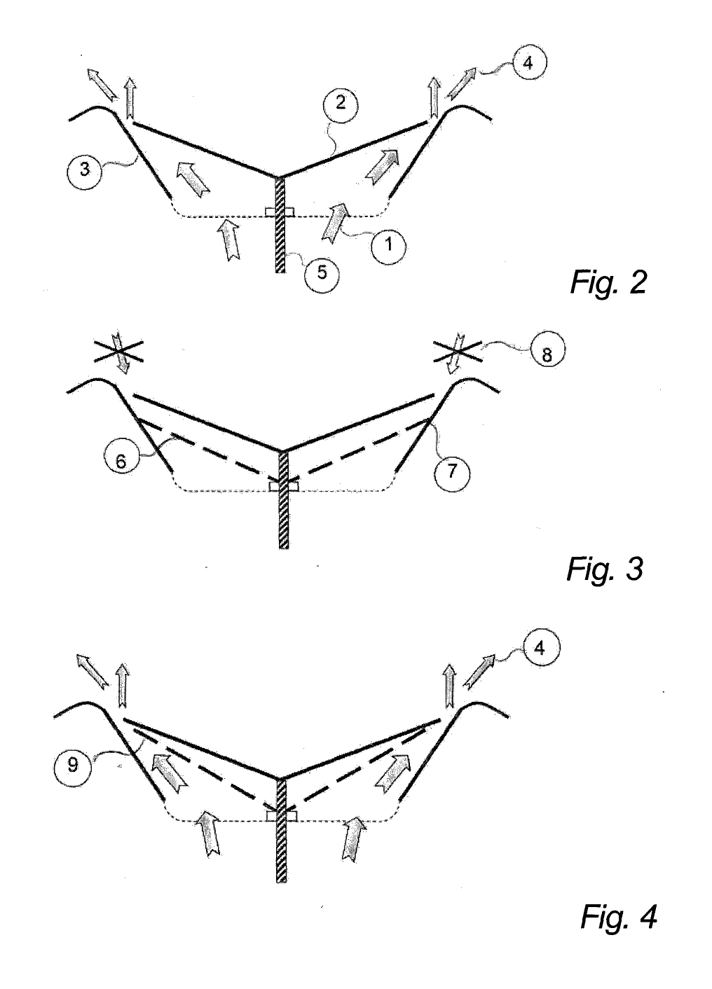

FIG. 1 shows a plastic disc (6) cut in a circular shape with a diameter corresponding to the air valve concerned, which is typically between 80 and 160 mm in diameter. The plastic material can e.g. be polypropylene or PET with a thickness of around 120 μm so that it can bend under a typical airflow to the nozzle. The disc is provided with one or more slots or notches (10) so that it rests on the side of the air valve (3) in FIG. 2. FIG. 1 also shows a hole (11) for mounting on a screw for adjusting the position of the cover plate (2) in FIG. 2.

FIG. 2 shows a typical known air inlet valve without the plastic disc fitted. Typically, an adjusting screw (5) is provided so that the height of the cover plate (2) in relation to the housing (3) can be adjusted to vary the airflow, indicated here with arrows (1) and (4).

FIG. 3 shows the air valve with the plastic disc (6) fitted, which now functions as a check valve plate which does not permit back-flowing air, here indicated with arrow (8). The plastic disc fits tightly against the side of the valve housing (3) all round, as indicated at point (7).

FIG. 4 shows an operating state where the air is pressed into the valve, causing the plastic disc to bend away and allow air to pass. This is shown at point 9. The degree of bending depends on several things. These include the thickness of the plastic material, the type of plastic, the number and length of slots (FIG. 1, point 10), so in this way it is possible to vary the properties of the flap according to the type of task to be solved. Finally, the property of plastic to have varying flexibility depending on temperature can be utilized. For example by suitable choice of material, the penetration of cold air can be prevented since plastic normally becomes less flexible with decreasing temperature.

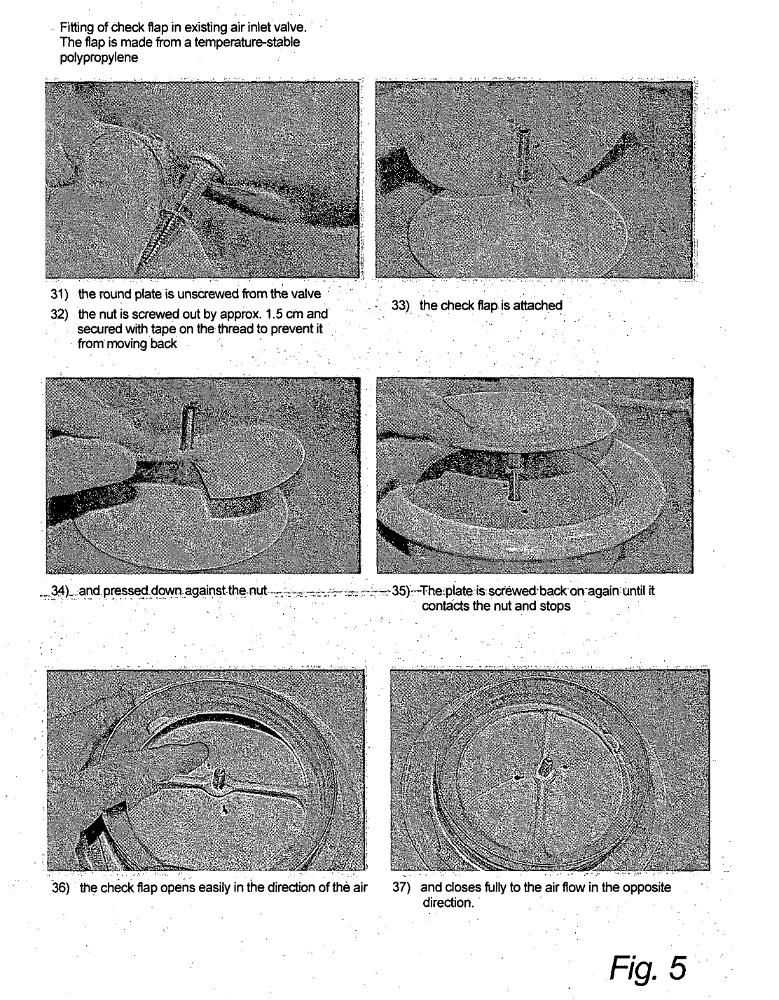

FIG. 5 shows a series of pictures of steps necessary for installation of a check valve plate according to an embodiment of the invention, in the form of a plastic disc in a known air inlet valve in accordance with a preferred embodiment of the invention. The method comprises steps 31 to 37, where:

Step 31 shows the round plate being unscrewed from the valve.

Step 32 shows that the nut is screwed out by approx. 1.5 cm and secured with tape on the thread to prevent it from moving back.

Step 33 shows the check flap being attached.

Step 34 shows it being pressed down against the nut.

Step 35 shows the plate being screwed back on again until it contacts the nut and stops.

Step 36 shows the check flap opening easily in the direction of the air, and

Step 37 shows it closing fully to air flow in the opposite direction.

Fitting of check flap in existing air inlet valve.

The flap in this example is made from a temperature-stable polypropylene.

1. Air inlet valve comprising:
a housing with an opening,
a cover plate,
a centered rod for connecting said cover plate to said housing,
a check valve plate which is made from a flexible sheet material and in which is provided at least one slot, extending from an outer perimeter of said check valve plate and towards a center, and
a central opening suitable for holding said check valve plate firmly on said centered rod, such that said check valve plate can be held firmly on said rod between said opening in said housing and said cover plate when said air inlet valve is assembled.

2. Air inlet valve according to claim 1, wherein the centered rod comprises an on the cover plate mounted centered adjusting screw suitable for cooperating with a centered hole with internal thread in the housing, such that said adjusting screw and said hole can cooperate to make a distance between said cover plate and said opening adjustable.

3. Air inlet valve according to claim 2, comprising a nut on the adjusting screw, such that the check valve plate is placed on said adjusting screw between the nut and the hole in the housing.

4. Air inlet valve according to claim 1, wherein said opening in said housing is circular and preferably funnel-shaped.

5. Air inlet valve according to claim 4, wherein said check valve plate has a substantially circular perimeter and a diameter which exceeds a diameter of the opening in the housing, such that the check valve plate will assume a pointed form when mounted in the air inlet valve.

6. Air inlet valve according to claim 1, wherein the at least one slot extends rectilinearly radially from the perimeter of the check valve plate and towards the center.

7. Air inlet valve according to claim 1, wherein the check valve plate is made from a sheet material, the flexibility of which is temperature-dependent, such that properties of said check valve plate as a check valve will be substantially changed between operating temperatures of 0° C. and 25° C.

8. Air inlet valve according to claim 1, wherein the check valve plate is made from a flexible plastic material and which has a thickness of between 80 and 200 μm.

9. Air inlet valve according to claim 1, wherein the check valve plate is made from a flexible polymer material.

10.-12. (canceled)

13. Air inlet valve according to claim 9, wherein the flexible polymer material comprises polycarbonate, polyester, synthetic materials with elastomer properties, polyethylene or a combination thereof.
